(19) United States
(12) Patent Application Publication
(10) Pub. No.: US 2016/0293915 A1
(43) Pub. Date: Oct. 6, 2016

(54) ELECTRIC STORAGE MODULE

(71) Applicant: TAIYO YUDEN CO., LTD., Tokyo (JP)

(72) Inventors: Takayuki TSUCHIYA, Takasaki-shi (JP); Shinji ISHII, Takasaki-shi (JP)

(21) Appl. No.: 15/082,963

(22) Filed: Mar. 28, 2016

(30) Foreign Application Priority Data
Mar. 31, 2015 (JP) 2015-072675

(51) Int. Cl. H01M 2/10; H01G 11/10; H01G 11/18

(52) U.S. Cl. CPC H01M 2/1094; H01G 11/18; H01G 11/10; H01M 2/1072

(57) ABSTRACT

An electric storage module includes an electric storage cell and a heat-conducting sheet. The heat-conducting sheet is layered with the electric storage cell and has insulation property, wherein the heat-conducting sheet has a relief structure constituted by convex parts and concave parts at least on one principle surface, and elasticity due to the elastic deformation of the concave parts. The electric storage module allows for size reduction and uses fewer parts.

### BACKGROUND

1. Field of the Invention

The present invention relates to an electric storage module that allows for size reduction and uses fewer parts.

2. Description of the Related Art

Assembled batteries (battery pack) used for industrial machinery, onboard equipment, etc., must be space-saving and lightweight. As assembled batteries have lately faced a demand for greater service current relative to the electric capacity, there is a need for ingenious discharge structures to accommodate heat generation from the cells. For this reason, current assembled batteries often use heat-conducting sheets, etc., to transmit the heat from the cells to the discharging members, and in many cases they are combined with pressurizing members to secure the cells in position (refer to Patent Literature 1, for example).

In addition, many assembled batteries are now using metal pressurizing members to sandwich the cells so that the cells will be secured to withstand vibration and impact (refer to Patent Literature 2, for example).

3. Background Art Literatures

[Patent Literature 1] Japanese Patent Laid-open No. Hei 08-321329

[Patent Literature 2] Japanese Patent Laid-open No. 2012-084551

### SUMMARY

However, the invention described in Patent Literature 1 may result in a large assembled battery as the discharging members are combined with the pressurizing members for securing the cells in place.

On the other hand, the invention described in Patent Literature 2 causes gaps to generate between the cells and a structure if the structure is designed with tolerances for parts. To pressurize the cells by eliminating these gaps, an adjustment function will be needed, which will make the assembled battery larger.

If the pressurizing members for securing the cells in place are made of metal, an insulation measure must be taken using insulating material; if they are made of resin, on the other hand, the resulting insulation property may be satisfactory, but the lack of strength will require a beam or other complex structure and tend to make the battery larger as a result. Furthermore, if heat discharge is of concern, a more complex structure will be needed because heat conduction paths must be provided, resulting in a greater number of parts.

In light of the situation above, an object of the present invention is to provide an electric storage module that allows for size reduction and uses fewer parts.

Any discussion of problems and solutions involved in the related art has been included in this disclosure solely for the purposes of providing a context for the present invention, and should not be taken as an admission that any or all of the discussion were known at the time the invention was made.

To achieve the aforementioned object, the electric storage module pertaining to an embodiment of the present invention has electric storage cells and a heat-conducting sheet.

The heat-conducting sheet is layered on the electric storage cells and has insulation property, a relief structure comprising convex and concave parts at least on one principle surface, and elasticity due to the elastic deformation of the convex parts.

According to this constitution, the heat-conducting sheet has convex parts and functions as an elastic sheet. Here, the convex parts deform elastically and thereby generate repulsion force in the heat-conducting sheet. This way, the heat-conducting sheet having convex parts can not only conduct the heat generated by the electric storage cells, but it can also pressurize the electric storage cells. In other words, the heat-conducting sheet can be integrally constituted by pressurizing members that pressurize the electric storage cells, and by a heat-conducting member. This means that, by using the heat-conducting sheet, an electric storage module can be provided that allows for size reduction and uses fewer parts.

The aforementioned convex parts may extend in a first direction parallel with the principle surface, and may be separated from each other by concave parts in a second direction parallel with the principle surface but orthogonal to the first direction.

According to this constitution, the convex parts extend in the first direction parallel with the principle surface and are separated from each other by the concave parts in the second direction. This way, the heat-conducting sheet contacts the electric storage cell over a larger area and thus can efficiently conduct the heat derived from the electric storage cell.

The convex parts may project in a third direction orthogonal to the first direction and second direction.

According to this constitution, the convex parts are constituted in a manner projecting in the third direction. This way, the electric storage cell is pressurized in the third direction and secured in place as a result. To be specific, the convex parts bite into the electric storage cell and get crushed and thereby generate repulsion force in the third direction, and this repulsion force is used to pressurize and secure the electric storage cell.

The convex parts may project in a direction angled from the third direction orthogonal to the first direction and second direction, toward the second direction.

Because the convex parts project in a direction angled toward the second direction, the direction in which the electric storage cell will be displaced when the electric storage module is affected by vibration, etc., can be regulated.

The convex parts may include convex parts projecting at different angles from the third direction.

According to this constitution, the convex parts may include convex parts projecting at different angles from the third direction. This way, the electric storage cell will no longer receive repulsion force from the convex parts in one direction only. In other words, the convex parts can not only pressurize the electric storage cell from one direction, but it can also do so from a different direction.

The convex parts may include first convex parts projecting in a direction angled from the third direction toward the second direction, and second convex parts projecting in a direction angled from the third direction toward the direction opposite to the second direction.

According to this constitution, the convex parts may include first convex parts projecting in a direction angled from the third direction toward the second direction, and second convex parts projecting in a direction angled from the third direction toward the direction opposite to the second direction. This way, the electric storage cell not only receives repulsion force from the first convex parts in a direction angled toward the second direction, but it also receives repulsion force from the second convex parts in a direction angled toward the direction opposite to the second direction, which reduces any displacement of the electric storage cell.

The direction in which the first convex parts project and the direction in which the second convex parts project may be symmetrical to the third direction.

Because the direction in which the first convex parts project and the direction in which the second convex parts project are symmetrical to the third direction, the first convex parts and second convex parts are angled in opposite directions, respectively, from the third direction at the same angle. Accordingly, the repulsion force given by the first convex parts to the electric storage cell becomes equivalent to the repulsion force given by the second convex parts to the electric storage cell. This eliminates any unevenness in the pressurizing force the electric storage cell receives from the heat-conducting sheet, which in turn suppresses displacement of the electric storage cell.

The convex parts may include first convex parts, and second convex parts whose height from the principle surface is lower than the corresponding height of the first convex parts.

According to this constitution, the convex parts can include first convex parts, and second convex parts whose height from the principle surface is lower than the corresponding height of the first convex parts. This way, the convex parts can be constituted in such a way that they pressurize the electric storage cell primarily using the first convex parts, while ensuring contact area with the electric storage cell using the second convex parts. Accordingly, because the convex parts include the first convex parts and second convex parts, they can pressurize the electric storage cell without causing the heat conduction efficiency to drop and without applying excessive weight.

The convex parts may extend in the first direction parallel with the principle surface, and may be separated from each other by the concave parts in the second direction parallel with the principle surface but orthogonal to the first direction.

According to this constitution, the convex parts including the first convex parts and the second convex parts whose height from the principle surface is lower than the corresponding height of the first convex parts, can be constituted in such a way that they extend in the first direction and are separated from each other by the concave parts in the second direction. This way, the convex parts can contact the electric storage cell over a larger area, which not only suppresses drop in heat conduction efficiency or excessive pressurization of the electric storage cell, but it also allows for efficient conduction of the heat derived from the heat storage cell.

The convex parts may project from the third direction orthogonal to the first direction parallel with the principle surface and the second direction parallel with the principle surface but orthogonal to the first direction, in a direction angled toward the principle surface.

According to this constitution, the convex parts including the first convex parts and the second convex parts whose height from the principle surface is lower than the corresponding height of the first convex parts, can also be constituted in such a way that they are angled in the direction of the principle surface. This not only suppresses drop in heat conduction efficiency or excessive pressurization of the electric storage cell, but it also allows for regulation of the direction in which the electric storage cell will be displaced.

The heat-conducting sheet may be made of silicone rubber.

Because the heat-conducting sheet is made of silicone rubber, the elastic force (repulsion force) of the convex parts of the heat-conducting sheet improves and the heat-conducting sheet does not generate permanent set easily. In other words, the heat-conducting sheet made of this material deteriorates less over time.

The electric storage cell may have an electric storage element, and an exterior film that covers the electric storage element and seals it together with electrolytic solution.

In general, an electric storage cell whose exterior material is film is not readily pressurized by the pressurizing members, etc., because the strength of the exterior material is low; with the electric storage cell pertaining to the present invention, on the other hand, the entire surface of the cell on the heat-conducting sheet side is covered by the heat-conducting sheet and therefore, even when an exterior film is applied, the cell can be pressurized efficiently by the heat-conducting sheet and secured in place as a result.

To achieve the aforementioned object, the electric storage module pertaining to an embodiment of the present invention has a first electric storage cell, second electric storage cell, heat-conducting sheet, first plate, and second plate.

The heat-conducting sheet is layered between the first electric storage cell and second electric storage cell, and has insulation property, a relief structure comprising convex and concave parts at least on one principle surface, and elasticity due to the elastic deformation of the convex parts.

The second plate sandwiches the first electric storage cell, second electric storage cell, and heat-conducting sheet together with the first plate, and pressurizes the first electric storage element and second electric storage element through the heat-conducting sheet, respectively.

According to this constitution, the heat-conducting sheet has convex parts and is layered between the first electric storage cell and second electric storage cell. Here, repulsion force can be generated in the heat-conducting sheet by means of elastic deformation of the convex parts. This way, the heat-conducting sheet having convex parts not only conducts the heat generated by the electric storage cells, but it can also pressurize the heat storage cells toward the first plate and second plate. In other words, the heat-conducting sheet can be integrally constituted by pressurizing members that pressurize the electric storage cells, and by a heat-conducting member. This means that, by using the heat-conducting sheet, an electric storage module can be provided that allows for size reduction and uses fewer parts.

As explained above, according to the present invention an electric storage module can be provided that allows for size reduction and uses fewer parts.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a perspective view of the electric storage module pertaining to an embodiment of the present invention.

FIG. 2 is an exploded perspective view of the electric storage module.

FIG. 3 shows a section view of the electric storage module.

FIG. 4 shows a section view of the electric storage cell pertaining to an embodiment of the present invention.

FIG. 5 is a perspective view of the heat-conducting sheet pertaining to an embodiment of the present invention.

FIG. 6 shows a side view of the heat-conducting sheet.

FIG. 7 shows a plan view of the heat-conducting sheet.

FIG. 8 shows a side view of the heat-conducting sheet.

FIG. 9 shows a side view of the heat-conducting sheet.

FIG. 10 shows a side view of the heat-conducting sheet.

FIG. 11 shows a side view of the heat-conducting sheet.

FIG. 12 shows a side view of the heat-conducting sheet.

FIG. 13 shows a side view of the heat-conducting sheet.

FIG. 14 is a drawing showing another structure of the heat-conducting sheet.

FIG. 15 is a drawing showing another structure of the heat-conducting sheet.

FIG. 16 is a drawing showing another structure of the heat-conducting sheet.

FIG. 17 is a drawing showing another structure of the heat-conducting sheet.

FIG. 18 is a drawing showing another structure of the heat-conducting sheet.

FIG. 19 is a drawing showing another structure of the heat-conducting sheet.

FIG. 20 is a drawing showing another structure of the heat-conducting sheet.

FIG. 21 is a section view of the heat storage module pertaining to a variation example of the present invention.

### DESCRIPTION OF THE SYMBOLS

10—Electric storage module

20—First electric storage cell

21—Second electric storage cell

30—Heat-conducting sheet

31—Convex part

32—Concave part

40—First plate

41—Second plate

50—First insulation sheet

51—Second insulation sheet

60—Support member

### DETAILED DESCRIPTION OF EMBODIMENTS

An embodiment of the present invention is explained below by referring to the drawings.

[Constitution of Electric Storage Module]

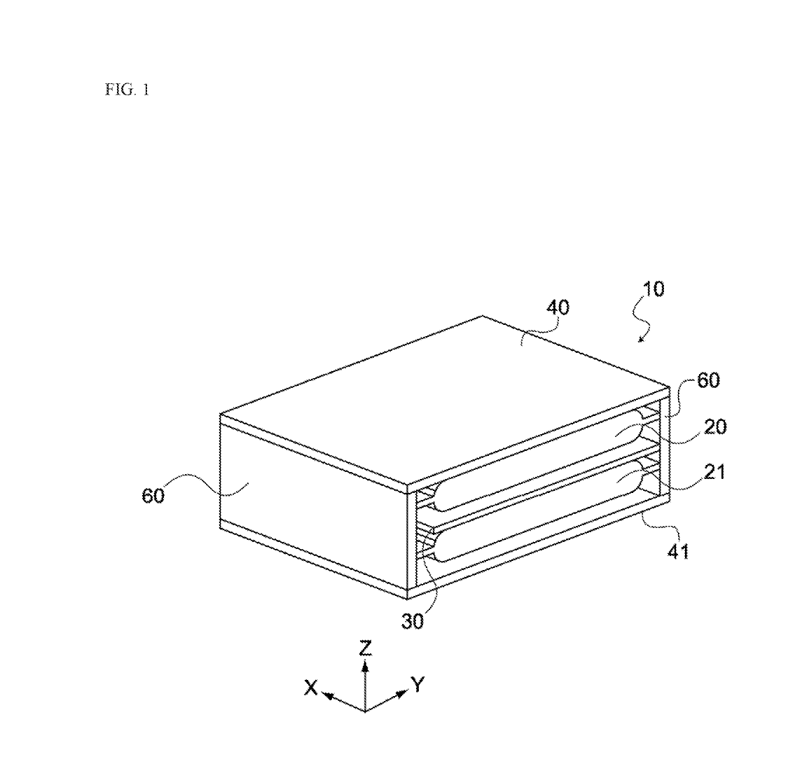

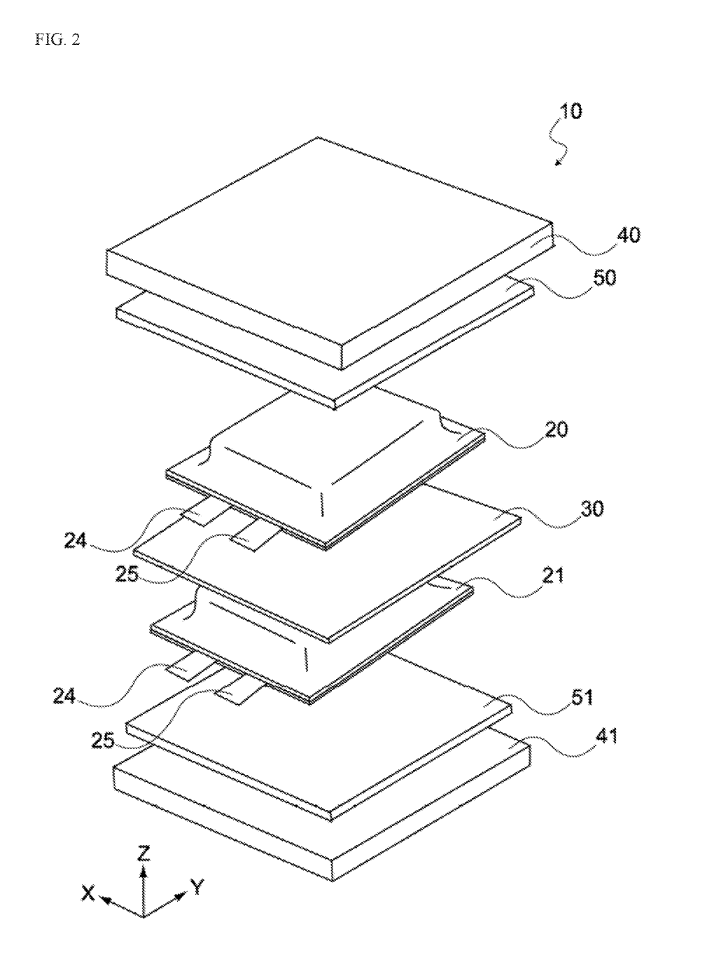

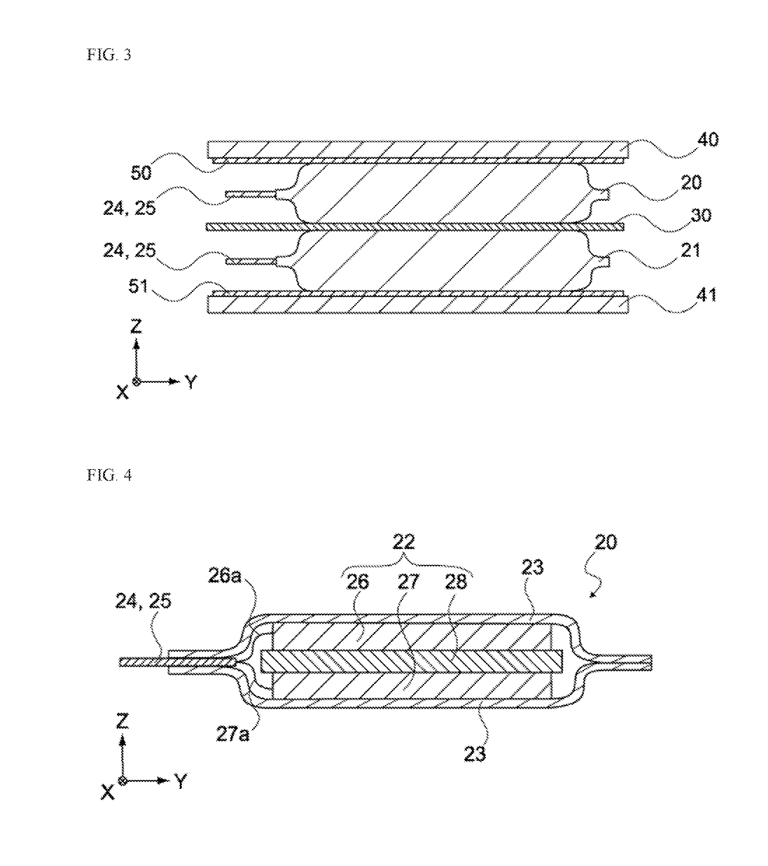

FIG. 1 is a perspective view of an electric storage module 10 pertaining to an embodiment of the present invention. FIG. 2 is an exploded perspective view of the electric storage module 10, while FIG. 3 is a section view of the same. It should be noted that the three directions of X, Y, and Z in the drawings below are orthogonal to each other.

As shown in FIG. 1 through FIG. 3, the electric storage module 10 pertaining to this embodiment has a first electric storage cell 20, second electric storage cell 21, heat-conducting sheet 30, first plate 40, second plate 41, first insulation sheet 50, second insulation sheet 51, and support members 60. It should be noted that the support members 60 are not illustrated in FIG. 2 and FIG. 3.

As shown in FIG. 2 and FIG. 3, the first electric storage cell 20 and second electric storage cell 21 are layered with the heat-conducting sheet 30 in between. The first plate 40 is layered via the first insulation sheet 50 on the side of the first electric storage cell 20 opposite to the heat-conducting sheet 30, while the second plate 41 is layered via the second insulation sheet 51 on the side of the second electric storage cell 21 opposite to the heat-conducting sheet 30. The first plate 40 and second plate 41 are supported by the support members 60 in a manner pressurizing each other, and sandwich the first electric storage cell 20 and second electric storage cell 21 via the heat-conducting sheet 30.

The first electric storage cell 20 can charge and discharge electricity. FIG. 4 is a schematic diagram showing the structure of the first electric storage cell 20. As shown in FIG. 4, the first electric storage cell 20 has an electric storage element 22, exterior film 23, positive electrode terminal 24, and negative electrode terminal 25.

The electric storage element 22, as shown in FIG. 4, has a positive electrode 26, negative electrode 27, and separator 28. The positive electrode 26 and negative electrode 27 face each other via the separator 28.

The positive electrode 26 may be made of positive electrode material containing positive electrode active material, binder, etc. The positive electrode active material is active carbon, for example. The positive electrode active material may be changed as deemed appropriate according to the type of the first electric storage cell 20. Also, the positive electrode 26 may be formed on a power collector continuing to a positive electrode wiring 26a.

The negative electrode 27 may be made of negative electrode material containing negative electrode active material, binder, etc. The negative electrode active material is carbon material, for example. The negative electrode active material may be changed as deemed appropriate according to the type of the first electric storage cell 20. Also, the negative electrode 27 may be formed on a power collector continuing to a negative electrode wiring 27a.

The separator 28 is placed between the positive electrode 26 and negative electrode 27, and lets electrolytic solution pass through while preventing the positive electrode 26 and negative electrode 27 from contacting each other (insulating the electrodes). The separator 28 may be made of woven fabric, nonwoven fabric, synthetic resin micro-porous membrane, etc.

While one positive electrode 26 and one negative electrode 27 are provided in FIG. 4, there can be multiple electrodes for each polarity. In this case, the multiple positive electrodes 26 and negative electrodes 27 may be layered alternately via the separator 28.

The exterior film 23, as shown in FIG. 4, covers the electric storage element 22 and seals the electric storage element 22 together with electrolytic solution. The exterior film 23 may be, for example, a metal foil whose top surface and bottom surface are both covered with synthetic resin, where the synthetic resin is thermally fused along the periphery of the electric storage element 22 to seal the interior.

In general, an electric storage cell whose exterior material is film is not readily pressurized by the pressurizing members, etc., because the strength of the exterior material is low; with the first electric storage cell 20 and second electric storage cell 21 pertaining to this embodiment, on the other hand, the entire surface of the cell on the heat-conducting sheet 30 side is covered by the heat-conducting sheet 30 (refer to FIG. 3) and therefore, even when the exterior material is film, the cell can be pressurized efficiently toward the first plate 40 and second plate 41 by the heat-conducting sheet 30 and secured in place as a result. It should be noted that the first electric storage cell 20 need not have the exterior film 23, and it can be other exterior material such as a can package.

The electrolytic solution may be, for example, a solution prepared by dissolving SBP.BF₄ (spirobipyrrolidinium tetrafluoroborate) or other electrolyte in propylene carbonate or other non-aqueous solvent, to be selected according to the type of the first electric storage cell 20.

The positive electrode terminal 24 is an external terminal of the positive electrode 26. As shown in FIG. 4, the positive electrode terminal 24 is electrically connected to the positive electrode 26 via the positive electrode wiring 26a, and led out to the outside through the space between two exterior films 23. The positive electrode terminal 24 may be a foil or wire made of conductive material. The positive electrode terminal 24 and positive electrode wiring 26a may be joined by ultrasonic welding, etc.

The negative electrode terminal 25 is an external terminal of the negative electrode 27. As shown in FIG. 4, the negative electrode terminal 25 is electrically connected to the negative electrode 27 via the negative electrode wiring 27a, and led out to the outside through the space between two exterior films 23. The negative electrode terminal 25 may be a foil or wire made of conductive material. The negative electrode terminal 25 and negative electrode wiring 27a may be joined by ultrasonic welding, etc.

The type of the first electric storage cell 20 is not limited in any way, and may be a lithium ion capacitor, lithium ion battery, electric double-layer capacitor, etc. Also, the constitution of the first electric storage cell 20 is not limited to the constitution in FIG. 4 and, for example, a constitution where the electric storage element 22 is sealed by one exterior film 23 is also possible.

The second electric storage cell 21 can charge and discharge electricity and may have the same structure as the first electric storage cell 20. The second electric storage cell 21 may also have a structure different from the first electric storage cell 20.

The heat-conducting sheet 30, as shown in FIG. 1 through FIG. 3, is pressurized by the first electric storage cell 20 and second electric storage cell 21. The heat-conducting sheet 30 functions to conduct the heat generated by the first electric storage cell 20 and second electric storage cell 21, to the first plate 40 or second plate 41.

The heat-conducting sheet 30 may be made of material having insulation property, heat conductivity, and rigidity of a certain level or more (resistance to distortion). It may be made of vinyl methyl silicone rubber or other silicone rubber, for example, but the material is not limited to the foregoing. The heat-conducting sheet 30 will be discussed later.

The first plate 40, as shown in FIG. 2 and FIG. 3, is layered on the first insulation sheet 50 and functions to discharge the heat generated by the first electric storage cell 20 and second electric storage cell 21. The first plate 40 is made of metal material and may be a metal plate made of aluminum, for example, but it can also be a metal plate made of copper, nickel, stainless steel, etc. Because the first plate 40 is made of metal, the heat derived from the first electric storage cell 20 and second electric storage cell 21 is discharged efficiently. The thickness of the first plate 40 may be several millimeters or so (e.g., 5 mm 4 mm).

The second plate 41, as shown in FIG. 2 and FIG. 3, is layered on the second insulation sheet 51 and functions to discharge the heat generated by the first electric storage cell 20 and second electric storage cell 21. The second plate 41 may be made of the same material as the first plate 40, and may be several millimeters or so (e.g., 5 mm±4 mm) thick.

The first insulation sheet 50, as shown in FIG. 2 and FIG. 3, is layered between the first electric storage cell 20 and first plate 40. The first insulation sheet 50 is made of material having insulation property, to prevent the positive terminal 24 and negative terminal 25 of the first electric storage cell 20 from contacting the first plate 40 (insulating the terminals and plate). The first insulation sheet 50 may be made of synthetic resin or synthetic rubber, for example. The thickness of the first insulation sheet 50 may be several millimeters or so (e.g., 5 mm±4 mm).

The second insulation sheet 51, as shown in FIG. 2 and FIG. 3, is layered between the second electric storage cell 21 and second plate 41. The second insulation sheet 51 prevents the positive terminal 24 and negative terminal 25 of the second electric storage cell 21 from contacting the second plate 41 (insulating the terminals and plate). The second insulation sheet 51 may be made of the same material as the first insulation sheet 50 and may be several millimeters or so (e.g., 5 mm±4 mm) thick.

The electric storage module 10 pertaining to this embodiment has the constitution described below.

[Heat-Conducting Sheet]

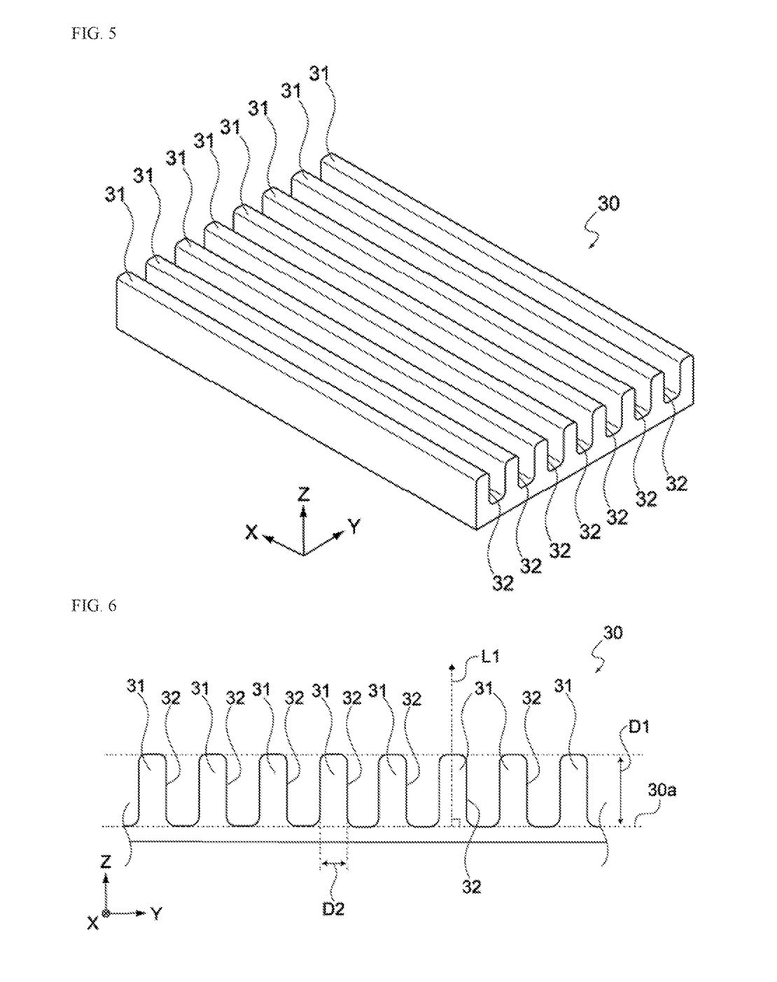

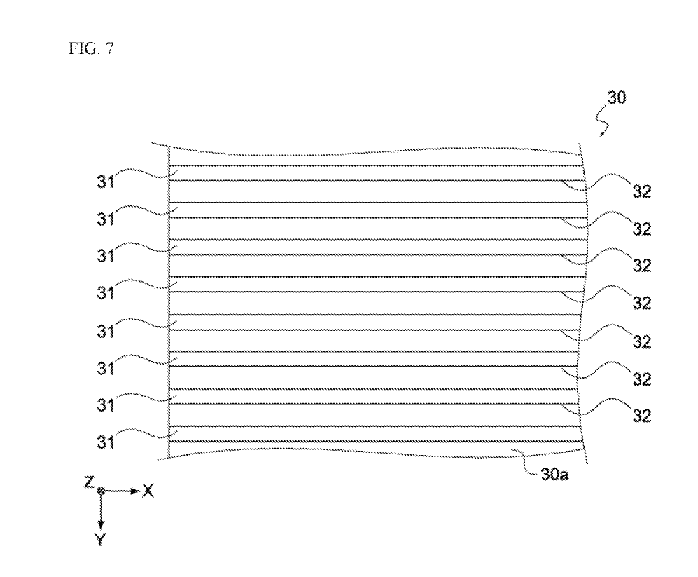

The details of the heat-conducting sheet 30 are explained. FIG. 5 is a perspective view of the heat-conducting sheet 30. Also, FIG. 6 is a side view of the heat-conducting sheet 30, while FIG. 7 is a plan view of the same.

The heat-conducting sheet 30, as shown in FIG. 5 and FIG. 6, has a relief structure comprising convex parts 31 and concave parts 32. The convex parts 31 and concave parts 32 are provided at least on one principle surface 30a of the heat-conducting sheet 30.

Here, assume that the X direction represents a direction parallel with the principle surface 30a, Y direction represents a direction parallel with the principle surface 30a and orthogonal to the X direction, and Z direction represents a direction orthogonal to the X direction and Y direction; then, the convex parts 31 are constituted, as shown in FIG. 5 through FIG. 7, in a manner extending in the X direction and separated from each other by the concave parts 32 in the Y direction.

Also, the convex parts 31 are constituted, as shown in FIG. 6, in a manner extending in the Z direction. In other words, the convex parts 31 extend in the X direction as mentioned above, or specifically they have a uniform shape in the X direction, meaning that they project along the X-Z plane (arrow L1 in the figure).

In some embodiments, the convex parts 31 are geometrically regularly arranged with specific pitches or intervals (with a repeating pattern). In some embodiments, the convex parts 31 are continuous entirely along the X-Z plane or intermittently arranged along the X-Z plane. In some embodiments, the heat-conducting sheet 30 has a thickness which is roughly the same as that of the insulation sheet 51, 52 or of several millimeters or so (e.g., 5 mm±4 mm). In some embodiments, the heat-conducting sheet 30 has rigidity substantially equivalent to that of vinyl methyl silicone rubber. In some embodiments, the electric storage cell is immovably secured to the elastic sheet by repulsion force (or elasticity) created by compressing the convex parts against the electric storage cell. In some embodiment, the repulsion force is primary and indispensible force for immovably securing the electric storage cell, and the electric storage cell is not immovably secured without the repulsion force.

[Effects of Heat-Conducting Sheet]

The heat-conducting sheet 30 pertaining to this embodiment can generate repulsion force in the heat-conducting sheet 30 by means of elastic deformation of the convex parts 31.

This way, not only can the heat generated by the first electric storage cell 20 and second electric storage cell 21 be conducted, but the first electric storage cell 20 can be pressurized toward the first plate 40 and the second electric storage cell 21 can be pressurized toward the second plate 41, as well. Accordingly, the heat-conducting sheet 30 can be integrally constituted by the pressurizing members that pressurize the first electric storage cell 20 and second electric storage cell 21, and the heat-conducting member. Here, preferably the pressure with which the heat-conducting sheet 30 pressurizes the first electric storage cell 20 and second electric storage cell 21 is 0.012 MPa.

The heat-conducting sheet 30 pertaining to this embodiment can be constituted, as mentioned above, in a manner having the convex parts 31 that extend in the X direction parallel with the principle surface 30a and are separated from each other by the concave parts 32 in the Y direction, parallel with the principle surface 30a and orthogonal to the X direction (refer to FIG. 5 through FIG. 7).

This way, the heat-conducting sheet 30 contacts the first electric storage cell 20 and second electric storage cell 21 over a larger area via the convex parts 31, and thus can efficiently conduct the heat derived from the first electric storage cell 20 and second electric storage cell 21 to the first plate 40 or second plate 41. Here, the heat conductivity of the heat-conducting sheet 30 is preferably 0.8 W/m.K or more, or more preferably 1.1 W/m.K or more.

Also, as shown in FIG. 6, because the convex parts 31 are constituted in a manner projecting in the direction of arrow L1, they can pressurize the first electric storage cell 20 and second electric storage cell 21 in the Z direction and secure them in place. To be specific, the convex parts 31 bite into the first electric storage cell 20 and second electric storage cell 21 and get crushed and thereby generate repulsion force in the Z direction, and this repulsion force is used to pressurize and secure the first electric storage cell 20 or second electric storage cell 21. Furthermore, the convex parts 31, as shown in FIG. 6, allow the repulsion force with which to pressurize the first electric storage cell 20 and second electric storage cell 21 to be adjusted by means of adjusting D1 and D2, where D1 represents the height from the principle surface 30a and D2 represents the width.

In addition, the heat-conducting sheet 30 has insulation property. This means that, by being layered between the first electric storage cell 20 and second electric storage cell 21, as shown in FIG. 3, it can prevent shorting of the electric storage module 10 as a result of contact between the positive electrode terminal 24 and negative electrode terminal 25 of the first electric storage cell 20 on one hand, and the positive electrode terminal 24 and negative electrode terminal 25 of the second electric storage cell 21 on the other.

Furthermore, when the heat-conducting sheet 30 is made of silicone rubber such as vinyl methyl silicone rubber, the elastic force (repulsion force) of the convex parts 31 of the heat-conducting sheet 30 improves and the sheet does not generate permanent set (permanent strain) easily. In other words, the heat-conducting sheet 30 made of this material deteriorates less over time.

A conventional heat-conducting sheet uses the elastic force derived from the rubber elasticity of its material to pressurize an electric storage cell. Because of this, the sheet will generate more permanent set if used continuously for a long time, and eventually lose all pressurizing force in several hours.

On the other hand, the heat-conducting sheet 30 pertaining to the present invention is made of hard material and pressurizes the electric storage cell using the elastic force of the convex parts 31, resulting in less repulsion force received from the electric storage cell compared to when a conventional heat-conducting sheet is used, and the sheet does not generate permanent set easily.

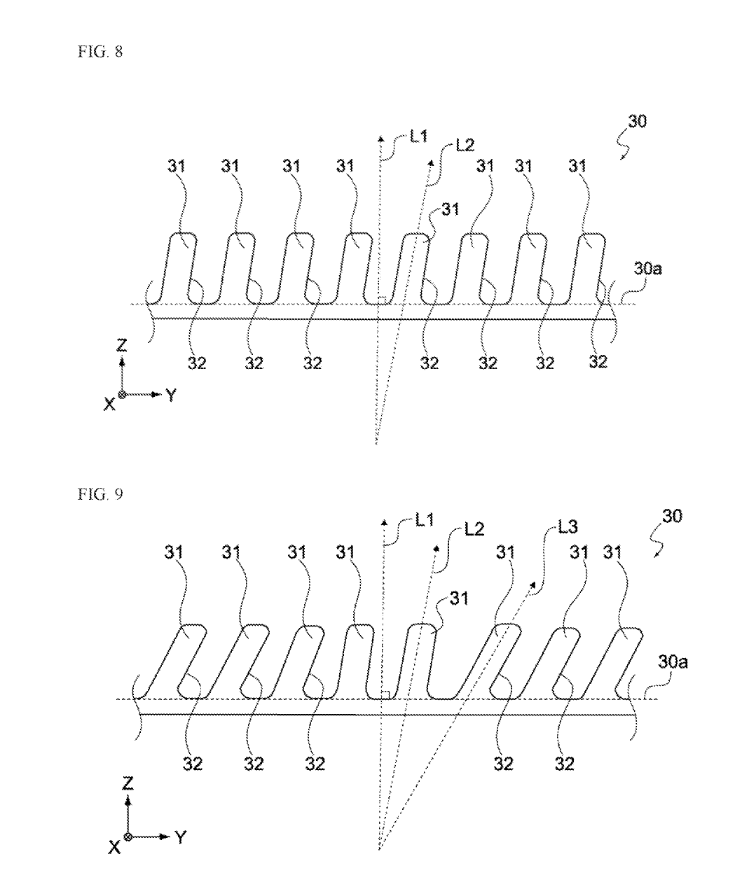

FIG. 8 through FIG. 13 are side views of heat-conducting sheets 30 having various structures. The convex parts 31 may be constituted in a manner not only having the shapes shown in FIG. 5 through FIG. 7, but also projecting in a direction angled from the Z direction toward the Y direction, as shown in FIG. 8.

To be specific, as shown in FIG. 8, the convex parts 31 may be constituted in a manner projecting in the direction of arrow L2, when the plane angled in the Y direction from the plane orthogonal to the principle surface 30a as denoted by arrow L1, is denoted by arrow L2. This way, the direction in which the first electric storage cell 20 and second electric storage cell 21 will be displaced when the electric storage module 10 is affected by vibration, etc., can be regulated.

The convex parts 31, as shown in FIG. 9, may project at different angles from the Z direction. To be specific, as shown in FIG. 9, the convex parts 31 may include convex parts 31 projecting in the direction of arrow L2 and convex parts 31 projecting in the direction of arrow L3, when the plane angled differently from arrow L2 in the Y direction from the plane orthogonal to the principle surface 30a as denoted by arrow L1, is denoted by arrow L3.

This way, the first electric storage cell 20 and second electric storage cell 21 no longer receive repulsion force from the convex parts 31 in one direction. In other words, the convex parts 31 can pressurize the first electric storage cell 20 and second electric storage cell 21 not only from one direction, but they can also pressurize them from other directions.

In addition, the convex parts 31 may include convex parts 31b projecting in a direction angled from the Z direction toward the Y direction, as well as convex parts 31c projecting in a direction angled from the Z direction toward a direction opposite to the Y direction.

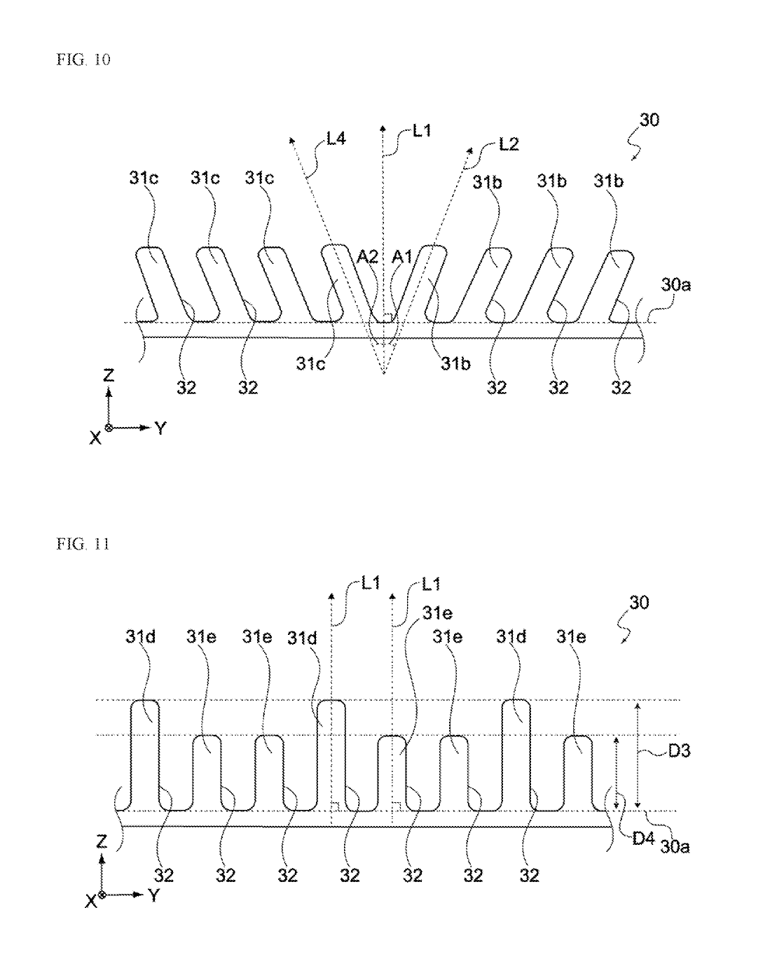

To be specific, as shown in FIG. 10, the constitution may be such that the convex parts 31b project in the direction of arrow L2, while the convex parts 31c project in the direction of arrow L4, when the plane angled from the plane orthogonal to the principle surface 31a as denoted by arrow L1, toward the direction opposite to the Y direction, is denoted by arrow L4.

This way, the first electric storage cell 20 and second electric storage cell 21 not only receive repulsion force from the convex parts 31b in a direction angled toward the Y direction, but they also receive repulsion force from the convex parts 31c in a direction angled toward a direction opposite to the Y direction, which reduces the displacement of the first electric storage cell 20 and second electric storage cell 21.

In addition, the direction in which the convex parts 31b project and the direction in which the convex parts 31c project may be symmetrical to the Z direction. To be specific, as shown in FIG. 10, the angle A1 formed between the plane orthogonal to the principle surface 31a as denoted by arrow L1, and arrow L2, becomes the same as the angle A2 formed between arrow L1 and arrow L4.

In other words, the convex parts 31b and convex parts 31c, as shown in FIG. 10, may be angled in opposite directions from the Z direction at the same angle, respectively. Accordingly, the repulsion force given by the convex parts 31b to the first electric storage cell 20 and second electric storage cell 21 becomes equivalent to the repulsion force given by the convex parts 31c to the first electric storage cell 20 and second electric storage cell 21. This eliminates any unevenness in the pressurizing force the first electric storage cell 20 and second electric storage cell 21 receive from the heat-conducting sheet 30, which in turn suppresses displacement of the first electric storage cell 20 and second electric storage cell 21.

The convex parts 31 are not limited to the constitutions shown in FIG. 5 through FIG. 10 and, as shown in FIG. 11, may include convex parts 31d and convex parts 31e whose height from the principle surface 30a is lower than the corresponding height of the convex parts 31d. Here, the convex parts 31d and convex parts 31e, as shown in FIG. 11, may be constituted in such a way that they project in the direction of arrow L1 corresponding to the plane orthogonal to the principle surface 30a.

The convex parts 31d are such that, as shown in FIG. 11, their height D3 from the principle surface 30a is set so that the heat-conducting sheet 30 pressurizes the first electric storage cell 20 and second electric storage cell 21 at a specified pressure.

The convex parts 31e are such that, as shown in FIG. 11, their height D4 from the principle surface 30a is set so that contact area with the first electric storage cell 20 and second electric storage cell 21 can be ensured.

Accordingly, the heat-conducting sheet 30 can be constituted in such a way that it pressurizes the first electric storage cell 20 and second electric storage cell 21 primarily using the convex parts 31d, while ensuring contact area with the first electric storage cell 20 using the convex parts 31e.

This means that the heat-conducting sheet 30, because it has convex parts 31d and convex parts 31e, can pressurize the first electric storage cell 20 and second electric storage cell 21 without causing the heat conduction efficiency to drop and without applying excessive weight.

In addition, convex parts 31d and convex parts 31e allow the heat conductivity of the heat-conducting sheet 30, and the pressurizing force on the first electric storage cell 20 and second electric storage cell 21, to be adjusted by means of adjusting their quantities. To be specific, the ratio of the number of convex parts 31d and that of convex parts 31e that the heat-conducting sheet 30 has is preferably 1:8.

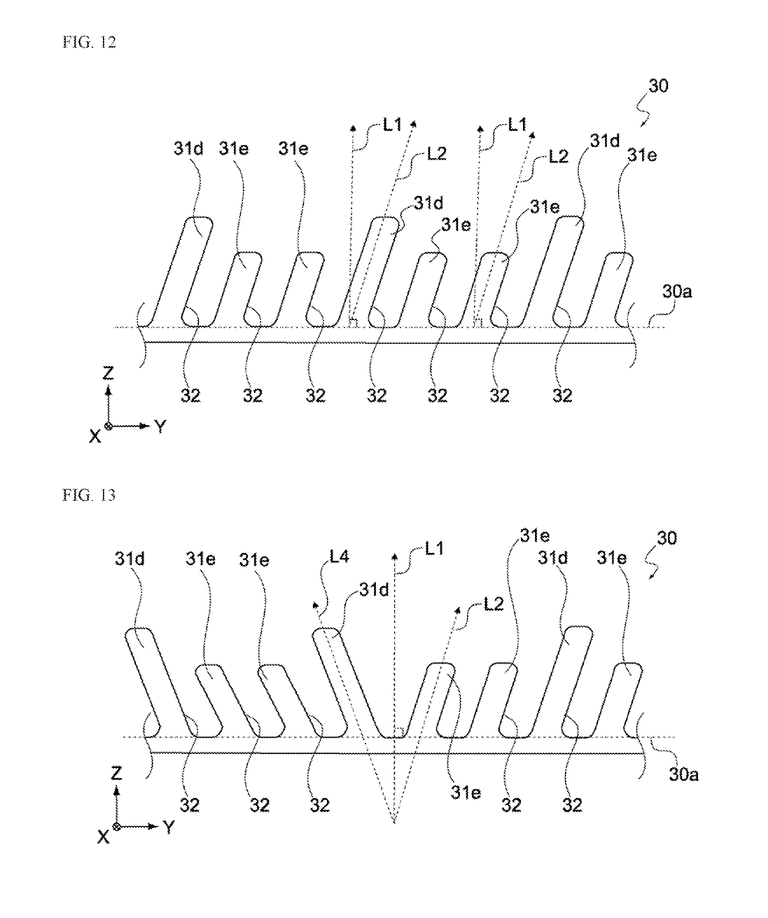

Furthermore, convex parts 31d and convex parts 31e, as shown in FIG. 12, may be constituted in a manner angled in the direction of the principle surface 30a. To be specific, as shown in FIG. 12, convex parts 31d and convex parts 31e may be constituted in such a way that they project from the plane orthogonal to the principle surface 30a as denoted by arrow L1, toward the direction of arrow L2 corresponding to the plane angled in the Y direction.

This way, not only can the drop in heat conduction efficiency and excessive pressurization of the first electric storage cell 20 and second electric storage cell 21 be suppressed, but the direction in which the first electric storage cell 20 and second electric storage cell 21 will be displaced can be regulated, as well.

The shapes of convex parts 31d and convex parts 31e are not limited to the constitutions in FIG. 11 and FIG. 12 and, as shown in FIG. 13, convex parts 31d and convex parts 31e may be constituted in a manner projecting at different angles from the Z direction.

To be specific, as shown in FIG. 13, the constitution may be such that convex parts 31e project toward the direction of arrow L2 corresponding to the plane angled in the Y direction from the plane orthogonal to the principle surface 31a as denoted by arrow L1, while convex parts 31d project toward the direction of arrow L4 corresponding to the plane angled in the direction opposite the Y direction from arrow L1. It should be noted that the directions in which convex parts 31d and convex parts 31e project are not limited to the constitution shown in FIG. 13, and convex parts 31d may project in the direction of arrow L2, while convex parts 31e may project in the direction of arrow L4.

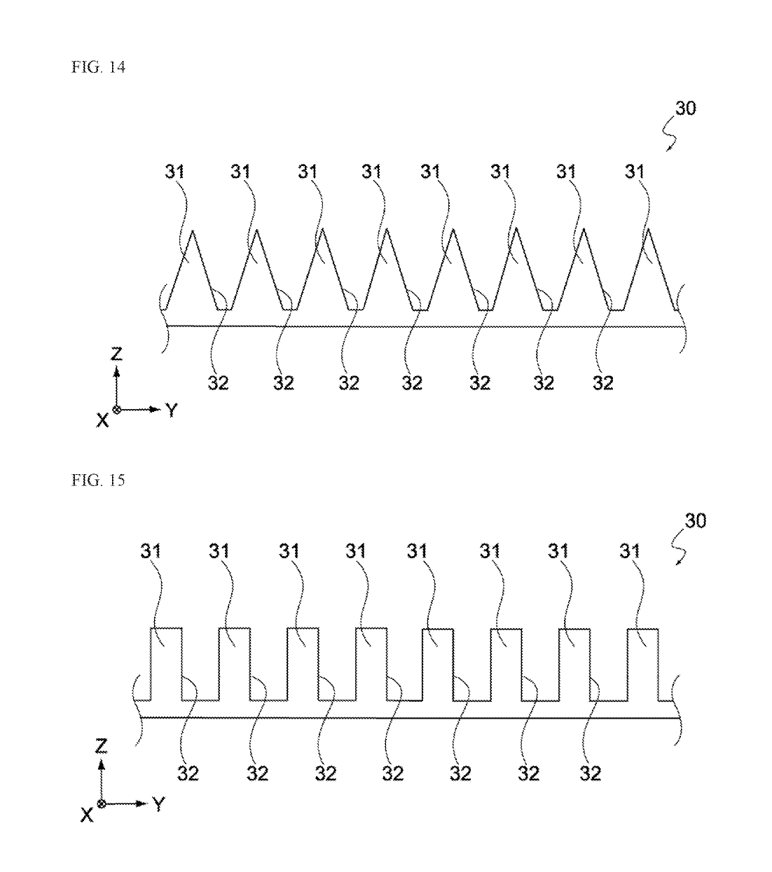

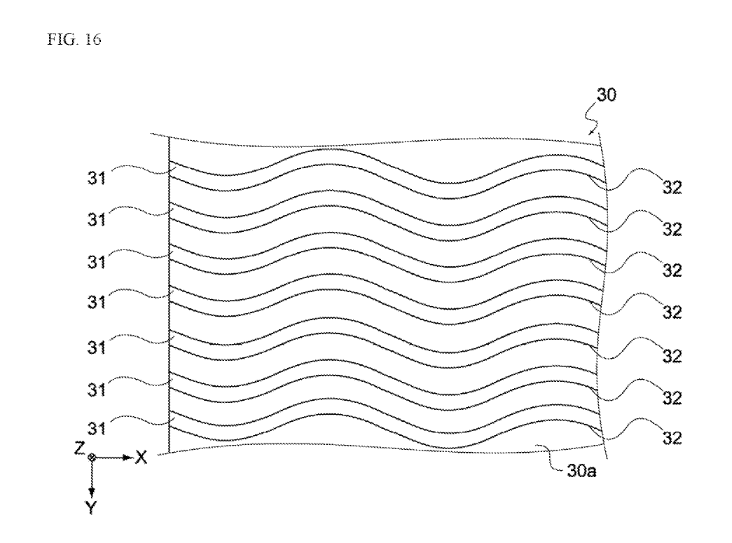

FIG. 14 through FIG. 19 show other shape structures of convex part 31. The shape of the convex part 31 as viewed from the X direction (side view of the convex part 31) is not limited to the constitution shown in FIG. 6 and, as shown in FIG. 14 and FIG. 15, it may be triangle or rectangle, among others. Also, its shape as viewed from the Z direction (plan view of the convex part 31) is not limited to the constitution shown in FIG. 7 and, as shown in FIG. 16 through FIG. 18, it may be wavy, curved, or straight with inflection points, among others.

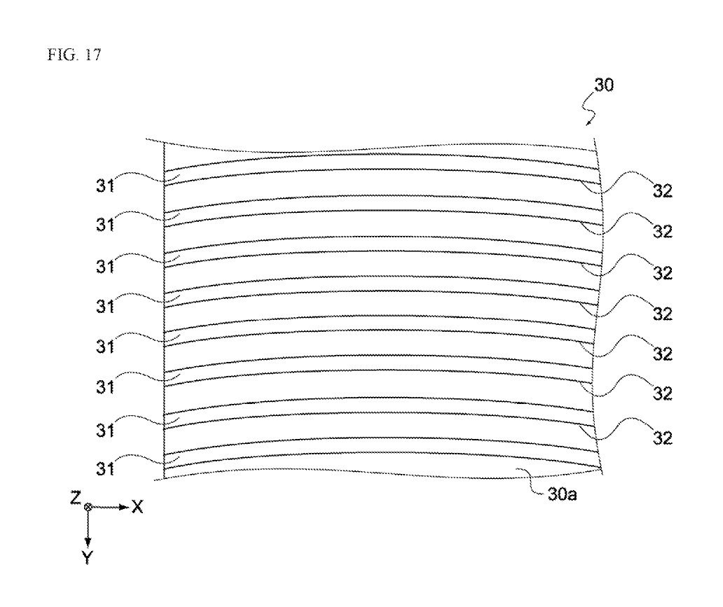

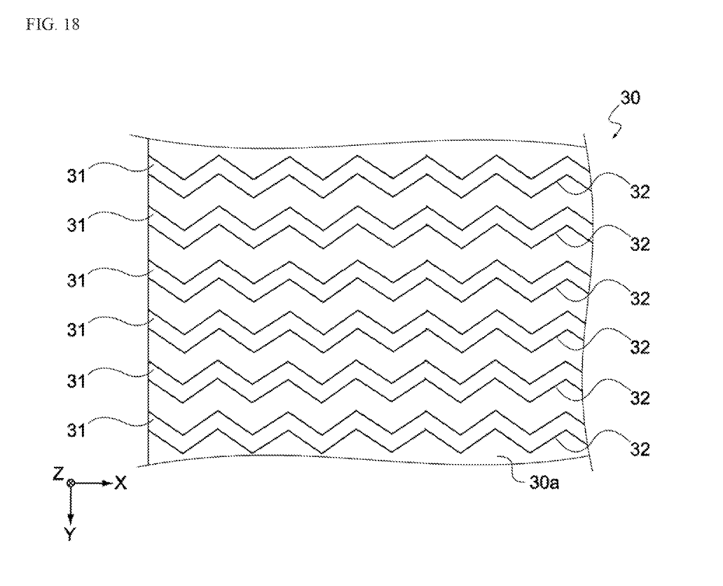

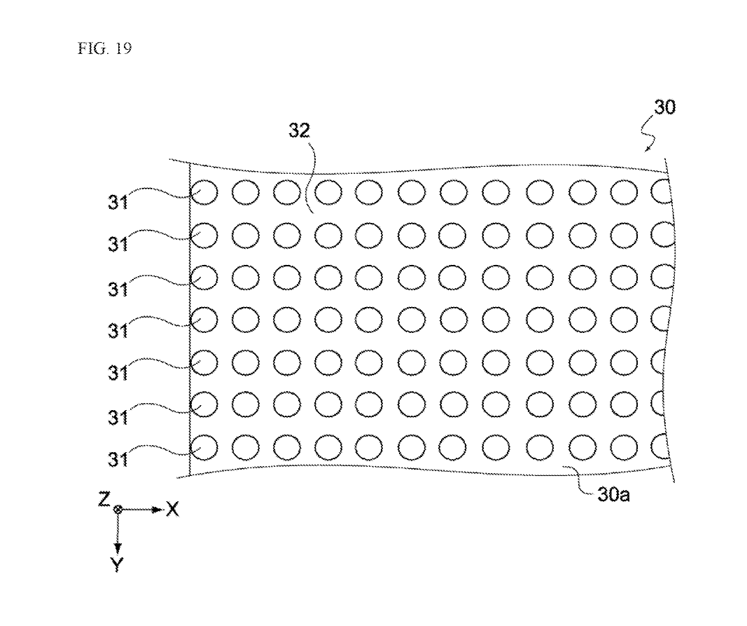

Also, the shape of the convex part 31 as viewed from the Z direction is not limited to the linear ones as shown in FIG. 7, FIG. 16, FIG. 17, and FIG. 18 and, as shown in FIG. 19, multiple, mutually independent convex parts 31 may be formed via concave parts 32.

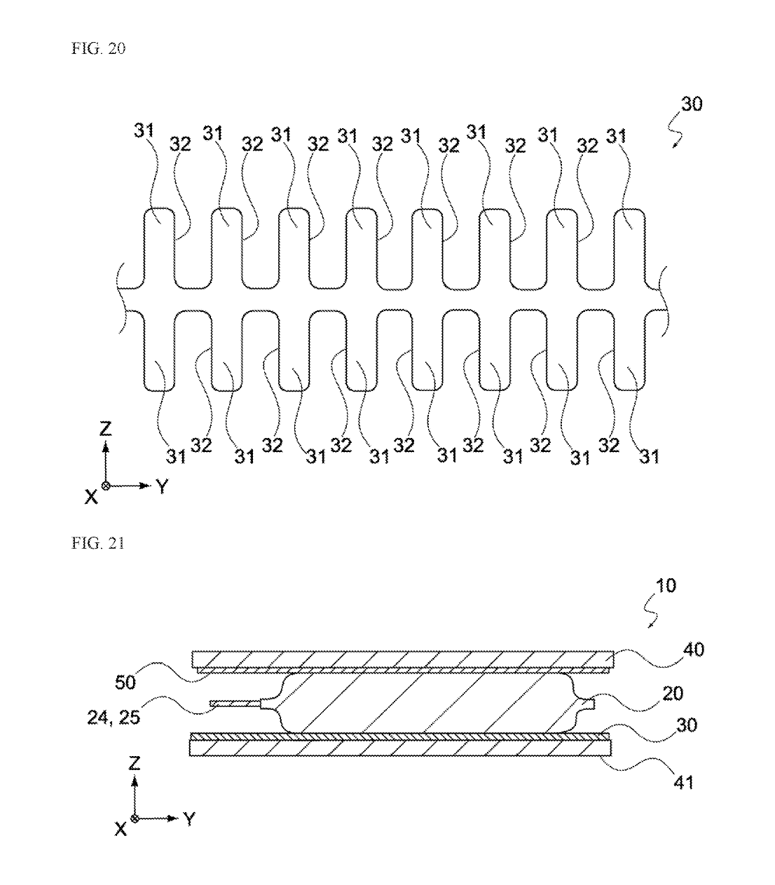

FIG. 20 is a schematic diagram showing other structure of the heat-conducting sheet 30. Convex parts 31, as shown in FIG. 20, may be provided on both sides, not on one side only, of the heat-conducting sheet 30.

### Variation Example

FIG. 21 is a section view showing the electric storage module 10 pertaining to a variation example. In the aforementioned embodiment, the electric storage module 10 has the first electric storage cell 20 and second electric storage cell 21, but it is not limited to this constitution. The electric storage module 10, as shown in FIG. 21, may only have the first electric storage cell 20, or it may have three or more electric storage cells. If the number of electric storage cells is 2 or greater, the top surface of the multiple electric storage cells is layered with the first insulation sheet 50, while the bottom surface is layered with the second insulation sheet 51.

Also, while the first plate 40 and second plate 41 are made of metal in the aforementioned embodiment, they may be made of synthetic resin or other insulation material. In this case, the first insulation sheet 50 and second insulation sheet 51 need not be provided in the electric storage module 10.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2015-072675, filed Mar. 31, 2015, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. An electric storage module comprising:
an electric storage cell; and
an elastic sheet layered with the electric storage cell and having insulation property, said elastic sheet having a patterned relief structure constituted by convex parts and concave parts at least on one principle surface of the elastic sheet.

2. An electric storage module according to claim 1, wherein the elastic sheet has heat conductivity.

3. An electric storage module according to claim 1, wherein the elastic sheet is made of silicone rubber.

4. An electric storage module according to claim 2, wherein the elastic sheet is made of silicone rubber.

5. An electric storage module according to claim 1, wherein the convex parts extend in a first direction parallel with the principle surface and are separated from each other by the concave parts in a second direction parallel with the principle surface but orthogonal to the first direction.

6. An electric storage module according to claim 5, wherein the convex parts project in a third direction orthogonal to the first direction and second direction.

7. An electric storage module according to claim 5, wherein the convex parts project from the third direction orthogonal to the first direction and second direction, toward the second direction.

8. An electric storage module according to claim 5, wherein the convex parts include convex parts projecting at different angles from the third direction.

9. An electric storage module according to claim 8, wherein the convex parts include first convex parts projecting in a direction angled from the third direction toward the second direction, as well as second convex parts projecting in a direction angled from the third direction toward the direction opposite to the second direction.

10. An electric storage module according to claim 9, wherein a direction in which the first concave parts project and a direction in which the second concave parts project are symmetrical to the third direction.

11. An electric storage module according to claim 1, wherein the convex parts include first convex parts, and second convex parts whose height from the principle surface is lower than a corresponding height of the first convex parts.

12. An electric storage module according to claim 11, wherein the convex parts extend in the first direction parallel with the principle surface, and are separated from each other by the concave parts in the second direction parallel with the principle surface but orthogonal to the first direction.

13. An electric storage module according to claim 12, wherein the convex parts project from the third direction orthogonal to the first direction parallel with the principle surface and the second direction parallel with the principle surface but orthogonal to the first direction, in a direction angled toward the principle surface.

14. An electric storage module according to claim 3, wherein the electric storage cell has an electric storage element and an exterior film that covers the electric storage element and seals it together with electrolytic solution.

15. An electric storage module according to claim 4, wherein the electric storage cell has an electric storage element and an exterior film that covers the electric storage element and seals it together with electrolytic solution.

16. An electric storage module according to claim 1, wherein the electric storage cell is immovably secured to the elastic sheet primarily by repulsion force created by compressing the convex parts against the electric storage cell.

17. An electric storage module having:
a first electric storage cell;
a second electric storage cell;
an elastic sheet layered between the first electric storage cell and second electric storage cell, having insulation property as well as a relief structure comprising convex parts and concave parts at least on one principle surface;
a first plate; and
a second plate that sandwiches, together with the first plate, the first electric storage cell, second electric storage cell, and elastic sheet.
